(19) United States
(12) Patent Application Publication
(10) Pub. No.: US 2002/0026248 A1
(43) Pub. Date: Feb. 28, 2002

(54) Data processing control system

(76) Inventors: Hiroshi Kaneko, Tokyo (JP); Satoshi Igarashi, Tokyo (JP)

Correspondence Address: FRISHAUF, HOLTZ, GOOGMAN, LANGER & CHICK, P.C., ATTORNEYS AT LAW, 767 THIRD AVENUE, NEW YORK, NY, 10017-2023, US

(21) Appl. No.: 09/793,481

(22) Filed: Feb. 26, 2001

(30) Foreign Application Priority Data
Feb. 28, 2000 (JP) 2000-50692

(51) Int. Cl. G05B 11/01

(52) U.S. Cl. 700/14; 700/306; 700/91

(57) ABSTRACT

Disclosed is a data processing control system for executing the progress routes of diversified data processing changing in various manners depending on the level of skill of users. The system comprises a task for controlling the processing based on the progress contents of various kinds of processing and the evaluation table storing, for each predetermined time zone, the corresponding processing content of each evaluation value of the predetermined skill, a log recording unit for recording the user's operation content as the log data, a measuring unit for measuring the passage time from the predetermined time, a timer for detecting the current time, a timer acquiring unit for acquiring the current time at the user's operation input time from the timer, an operation determining unit for determining the user's operation content based on the progress content of the scenario data and the record data and a branching processing unit for determining the user's evaluation value based on the determining result of the operation determining unit and the passage time and also determining the next processing content based on the determined evaluation value and the evaluation table corresponding to the time zone to which the current time belongs.

### BACKGROUND OF THE INVENTION

1. Field of the Invention

The present invention relates to a data processing control system for controlling data processing in accordance with a scenario data describing the contents of progress of the predetermined processing and particularly to a data processing control system that can reflect skills of users on the content of progress of the processing.

2. Description of the Background Art

In a conventional computer game machine, the progress of game is controlled generally on the basis of user's operation input depending on the scenario data describing the progress content of the predetermined processing, and a message or the like is produced while branching or skipping to the scenario data for the next process depending on this scenario data. Moreover, in such a game machine, progress of game is changed and content of message to be produced is changed depending on user's operation input content.

However, such a game machine has a problem that since the progress content and output message have determined patterns even when these are changed depending on user's operation content, users may be tired of playing the game because it becomes possible for users to assume the progress pattern while users are enjoying many times the same game.

Particularly, users executing the game have different skills for the game. Therefore if the game progresses in the similar manner or a similar message is outputted for the users in different skills, users having higher skills may easily be tired of playing the relevant game.

On the other hand, since users have different levels of skill for the game, it is truly impossible that operation, predetermined period and time until the achievement target is attained becomes identical even when the same game is progressed toward the identical achievement target.

### SUMMARY OF THE INVENTION

A principal object of the present invention is to provide a data processing control system that enables selection of various progress routes of game and message output by utilizing the skills of users explained above as the control information.

According to the present invention, the above-mentioned object can be attained with the data processing control system comprising:

a control unit for controlling the process based on a scenario data having a progress content of a predetermined processing and an evaluation table including the predetermined evaluation value and corresponding processing content;

a log recording unit for recording user's operation content as a log data;

a measuring unit for measuring the passage time from the predetermined time;

an operation determining unit for determining user's operation content based on the progress content of scenario data and the log data; and

a branching processing unit for determining evaluation values of users based on the determination result of the operation determining unit and the passage time and also determining the next processing content based on the determined evaluation value and the evaluation table.

In the data processing control system of the present invention, the processes, even if these are intended to attain the identical achievement target, do not always become identical depending on user's skill in the operation contents and passage time required until the achievement target is obtained and the processes progress in the contents selected from variety of contents of processes depending on the evaluation value.

According to the data processing control system of the present invention, the user's operation content is determined based on the progress content of scenario data and the log data, and the user's evaluation value is determined from the determination result of such operation content and passage time from the predetermined time. This evaluation time is the reference value of the skill of users. The determined user's evaluation value is made to correspond with the evaluation value in the evaluation table of the scenario data, and the processing content corresponding to the user's evaluation value is determined as the next processing content. Therefore, since the next processing content is determined depending on the skill of users determined from the user's operation content and passage time, progress operation in the non-identical processing contents changing in various manners can be realized.

Here, the evaluation table can be formed in such a structure that the evaluation value in a constant range is set corresponding to one processing content considering that the determined user's evaluation value has a certain width, in addition to the structure that one processing content is set corresponding to one evaluation value. Moreover, it is also possible that a plurality of tables are prepared for one scenario data depending on the progress content of processing. In this case, the branching processing unit is required to provide a processing stage to select one evaluation table from a plurality of evaluation tables at the time of determining the next processing content. Moreover, it is also allowed to provide, in the scenario data, the reference table for selecting using a plurality of evaluation tables.

As the log data, all operation contents of users can be recorded and only a constant operation can also be recorded depending on the progress content.

The passage time is enough to be the passage time from the predetermined time. For example, the passage time from the processing starting time such as the game starting time or the passage time from the time when a user has performed the predetermined operation can be determined depending on the processing content or the like.

The operation determining unit is not limited in the structure so long as it can determine the user's operation content. For example, in response to the progress content, it can be arbitrarily constituted so as to determine whether the user's operation content recorded in the log data is matched or not with the operation content described in the progress content of scenario data and to determine whether the user's input value belongs to the range described in the scenario data or not.

The branching processing unit is not particularly limited in the structure so long as it can determine the user's evaluation value based on the determining result of the operation determining unit and the passage time and also can determine the next processing content based on the determined evaluation value and evaluation table. Various modifications are Possible. For example, when the passage time is long, an evaluation value is increased and when the user's operation content is matched, the evaluation value content is increased. In addition, when the passage time is long, the evaluation value is reduced and when the user's operation content is matched, the evaluation value content is reduced and when the passage time is long, the evaluation value is increased and when the user's operation content is matched, the evaluation value content is reduced, or the like.

The “next processing content” in the present invention also includes the scenario data to be processed next and the message to be outputted next.

According to the preferred embodiment of the present invention, the data processing control system explained above further comprises a timer apparatus for detecting the current time and a timer acquiring unit for acquiring the current time of the user's operation input time from the timer apparatus. Accordingly, the scenario data includes a plurality of corresponding evaluation tables for each predetermined time zone. The branching processing unit determines the user's evaluation value based on the determination result of the operation determining unit and the passage time and also determines the next processing content based on the determined evaluation value and the evaluation table corresponding to the time zone to which the current time belongs.

In this case, even in the case of the processing toward the same achievement target, the other processing route is selected if the time for attaining the identical achievement target is different depending not only on the skill of users but also on the operation input time and thereby the progress operation in various processing content changing depending on such processing can be realized.

Moreover, a plurality of evaluation tables exist for each predetermined time zone within the scenario data and the branching processing unit determines the next processing content using the evaluation table corresponding to the time zone to which the current time at the user's operation input time belongs. Here, the user's operation input time may be arbitrarily determined during progress of the processing and moreover it is also possible to set the user's operation input time when the processing progress of the scenario data is completed.

As explained above, since the evaluation table is selected based on the current time at the user's operation input time and thereby the next processing content is determined, the progress operation in the various processing contents changing depending on the date and time for execution of the processing can be realized.

According to the other preferred embodiment of the present invention, the scenario data in the data processing control system explained above includes a plurality of evaluation tables for each predetermined passage time zone and the branching processing unit determines the user's evaluation value based on the determination result of the operation determining unit and the passage time and also determines the next processing content based on the determined evaluation value and the evaluation table corresponding to the passage time zone to which the passage time belongs.

In this case, since the passage time until the achievement target can be attained does not always become identical depending on the skills of users even in the case of the processing toward the identical achievement target, the evaluation table is selected using the information itself of this passage time and thereby the progress operation in the processing content changing in various manners depending on the passage time can be realized.

Namely, a plurality of evaluation tables are prepared for each predetermined passage time zone, and the next processing content is determined in the processing with the branching processing unit using the evaluation table corresponding to the passage time zone to which the actual passage time belongs. Since the evaluation table is changed based on the passage time as explained above and thereby the next processing content is determined, the progress operation in the processing content changing in various manners depending on difference of the passage time can be realized.

The present invention also provides the data processing control method for achieving the object explained above, said method comprising the steps of:

controlling a process based on a scenario data having a progress content of a predetermined processing and a evaluation table including the predetermined evaluation value and corresponding processing content;

measuring a passage time from the predetermined time;

determining the user's operation content based on the progress content of scenario data and log data of the user's operation content; and

determining the user's evaluation value based on the operation content determined in said step (3) and passage time measured in said step (2) and also determining the next processing content based on the determined evaluation value and evaluation table.

The data processing control method according to a preferred embodiment of the present invention further comprises a step for acquiring the current time at the user's operation input time with the timer apparatus, the scenario data includes a plurality of evaluation tables for each predetermined time zone, the user's evaluation value is determined in said step (4) based on the operation content determined in said step (3) and the passage time measured in said step (2), and the next processing content is determined based on the determined evaluation value and the evaluation table corresponding to the time zone to which the current time belongs.

The data processing control method and/or the preferred embodiment thereof of the present invention explained above can be provided in the form of a software program recorded in a computer-readable recording medium for execution thereof on a computer.

Such recording medium can be realized, for example, as a magnetic disc, optical disc, magneto-optical disc or semiconductor memory and the program recorded in this recording medium can be downloaded to a computer in the user side in direct or via the network using the well known drive unit.

The other features and advantages of the present invention will become more apparent from preferred embodiments with accompanying drawings that are only explained for indicating an example without limitation on the technical scope of the present invention. The preferred embodiment explained below is only an example where the present invention is adapted to the progress processing of the scenario data of the game machine, but the present invention is never limited thereto.

### BRIEF DESCRIPTION OF THE DRAWINGS

FIG. 1 is a block diagram illustrating a hardware structure of the game machine in relation to a preferred embodiment of the present invention.

FIG. 2 is a block diagram illustrating a software format of the game machine in relation to a preferred embodiment of the present invention.

FIG. 3 is a flowchart indicating an example of the progress content in the scenario data.

FIG. 4a is a schematic diagram of an example of the evaluation table, and FIGS. 4b to 4d are schematic diagrams indicating an example of a plurality of evaluation tables of different contents depending on the time.

FIG. 5 is a flowchart indicating the processing of the operation determinating unit.

FIG. 6 is a flowchart indicating the processing of the branching processing unit.

### DESCRIPTION OF THE PREFERRED EMBODIMENTS

Hardware structure of a game machine:

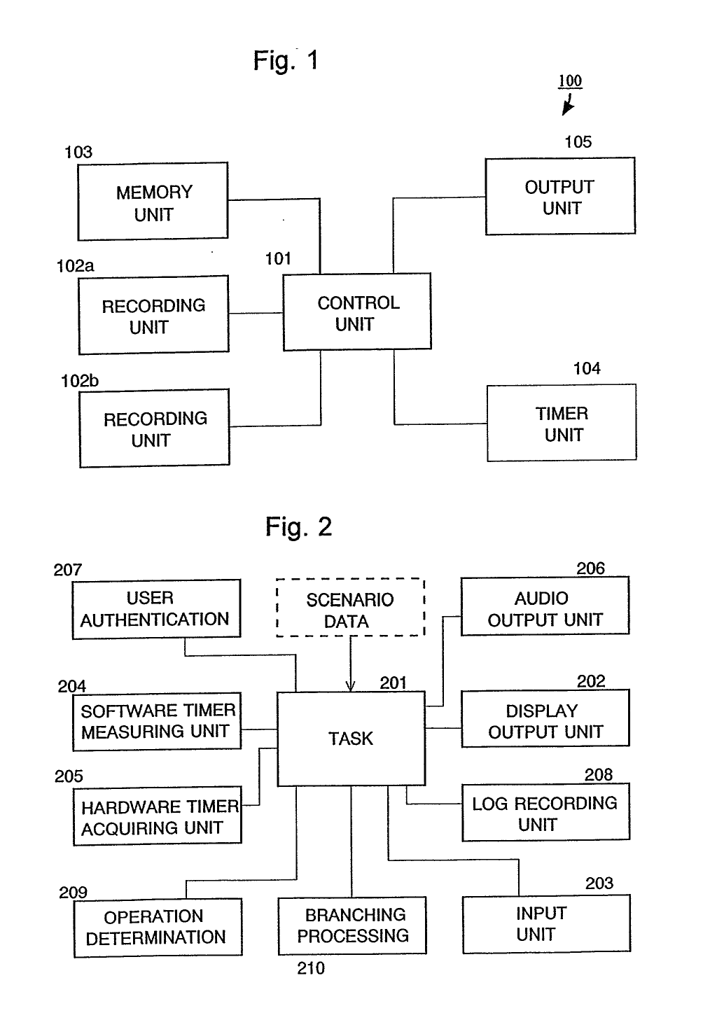

First, a hardware structure of the game machine according to the present embodiment will be explained. FIG. 1 shows a block diagram of a system configuration of the gate machine of the present embodiment.

As shown in FIG. 1, the game machine 100 comprises a control unit 101, recording units 102a and 102b, a memory unit 103, a timer unit 104 and an output unit 105 to form as a whole a system composition utilizing a computer system in the ordinary manner.

The control unit 101 is composed of an arithmetic unit such as CPU or the like to control the system as a whole and a read-only memory (ROM) or the like. The memory unit 103 is formed of an ordinary random access memory (RAM).

The recording unit 102a stores various contents materials used for progress of the game and comprises a recording medium such as ROMs and hard disc (HD), etc. Moreover, a hard disc drive (HDD) for controlling the read/write operation to the hard disc (HD) also corresponds to the recording unit 102a.

Another recording unit 102b is provided to record the history of the processing as a log data and includes a non-volatile RAM and a battery-backup circuit. The recording unit 102b forms a log recording unit defined in the present invention.

The timer unit 104 uses a real time clock of the battery-backup type and is used to acquire the current time at the desired timing.

The output unit 105 is provided to display and output various messages and includes a display or a speaker or the like.

Various processing programs to be executed in the game machine of this embodiment are provided by a CD-ROM, DVD-ROM or FD or the like in the file format that can be installed into the computer. These programs are read and executed respectively with CD drive, DVD drive or FD drive of the game machine or computer. In addition, various processing programs in this embodiment can also be provided in the file format recorded in a built-in ROM or removable ROM of the game machine. Moreover, it is also possible to provide various processing programs of this embodiment in the form of the file format that may be installed and/or executable via the network. In addition, it is further possible to update various programs and data via the network.

Functional structure of a game machine:

Next, the functional structure of the game machine 100 of this embodiment will be explained. FIG. 2 is a functional block diagram illustrating the functional structure of the game machine 100 of this embodiment.

As shown in FIG. 2, the game machine 100 of this embodiment comprises a task unit 201, in input processing unit 203, a software timer measuring unit 204, a hardware timer acquiring unit 205, a user authenticating unit 207, a log recording unit 208, an operation determining unit 209, a branching processing unit 210, an audio output unit 206 and a display output unit 202.

The task unit 201 is the trunk part of the processing and generates a primary task when a game is started. The task unit 201 controls the progress of processing of the game based on the scenario data and forms the control unit of the present invention. The task unit 201 is adapted to sequentially call, based on the scenario data, the input processing unit 203, software timer measuring unit 204, hardware timer acquiring unit 205, user authenticating unit 207, log recording unit 208, operation determining unit 209, branching processing unit 210, audio output unit 206 and display output unit 202.

The input processing unit 203 monitors all user operations and notifies these operations to the task unit. Operation of this input processing unit 203 is executed for each task during execution of task.

The software timer measuring unit 204 forms a measuring unit of the present invention and measures the passage time from the gate starting time. Also, the data having added the preceding application time of the same user can also be outputted from the software timer measuring unit.

The hardware timer acquiring unit 205 forms the timer acquiring unit of the present invention and acquires the current time from the timer apparatus 104.

The audio output unit 206 performs output processing of the audio data previously stored in the recording apparatus 102a. The display output unit 202 displays and outputs various messages that are previously accumulated in the recording apparatus 102a.

The user authenticating unit 207 determines the initial value of the processing by identifying a user. In the game machine of this embodiment, the user authenticating unit 207 is provided but it is also possible within the technical scope of the present invention that the user authenticating unit 207 is not provided.

The log recording unit 208 is provided to sequentially record the user's operation content of each user.

The operation determining unit 209 is provided to determine whether the user's operation recorded in the record data is matched with the scenario data or not. The operation determining unit 209 also generates the numeral data of the input timing.

The branching processing unit 210 determines the user's evaluation value based on the determination result of the user's operation content and passage time indicating the degree of progress of scenario. Moreover, the branching processing unit determines the scenario to be processed next, on the basis of the user's evaluation value and evaluation table.

Structure of scenario data:

The scenario data is composed of the progress schedule and aggregation of evaluation table (evaluation table group).

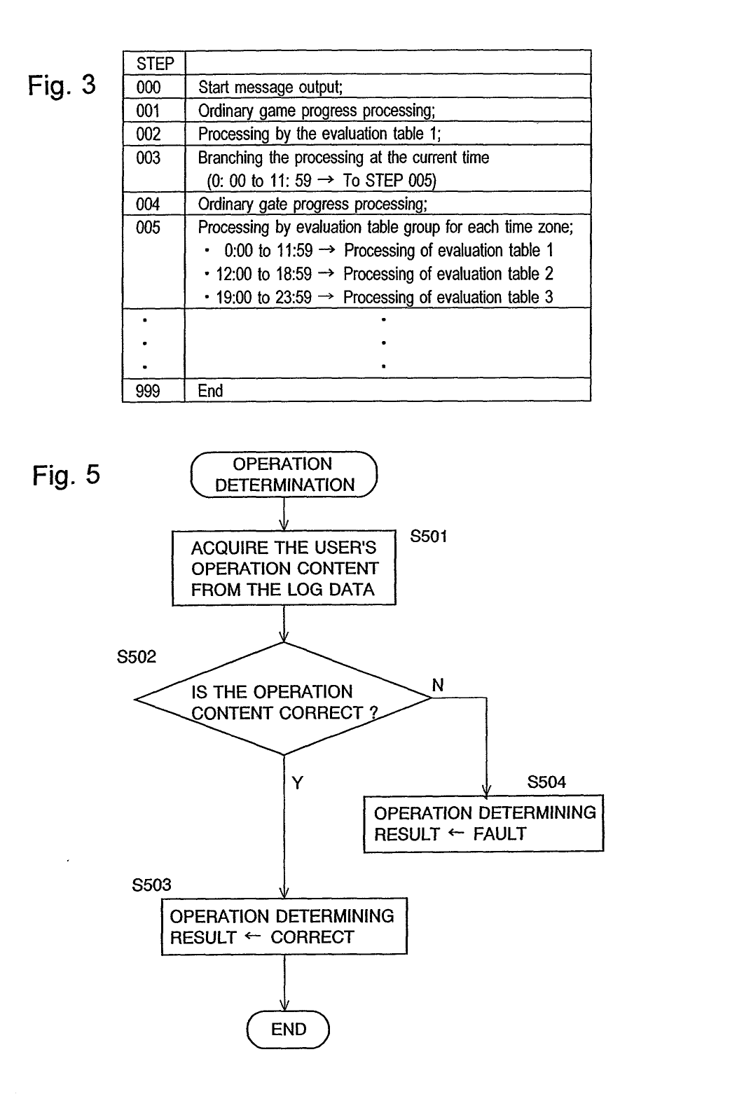

FIG. 3 shows an example of the summary of the progress schedule. As shown in FIG. 3, the start message is outputted first (STEP 000) and ordinary game progress processing is executed (STEP 001). Here, the ordinary game progress processing is different depending on the contents of game and the practical explanation of the processing is omitted here.

Next, the processing based on the evaluation table 1 explained later is executed (STEP 002). This processing is performed with the operation determining unit 209 and branching processing unit 210 which will be explained later in detail. Thereafter, the hardware timer acquiring unit 205 acquires the current time and branches to the STEP 005 when the current time is, for example, before “11:59” (STEP 003), or continues the ordinary game progress processing when the current time is after “12:00” (STEP 004).

In the STEP 005, the processing by the evaluation table group is performed to determine the next processing. This processing is performed with the operation determining unit 209 and branching processing unit 210. In this embodiment, as indicated in the STEP 005, the evaluation table 1 is selected when the current time belongs to the time zone up to 11:59 from 00:00, the evaluation table 2 is selected when the current time belongs to the time zone up to 18:59 from 12:00 or the evaluation table 3 is selected when the current time belongs to the time zone up to 23:59 from 19:00. Thereafter, the processing based on the respective evaluation table is performed to close the operation (STEP 999).

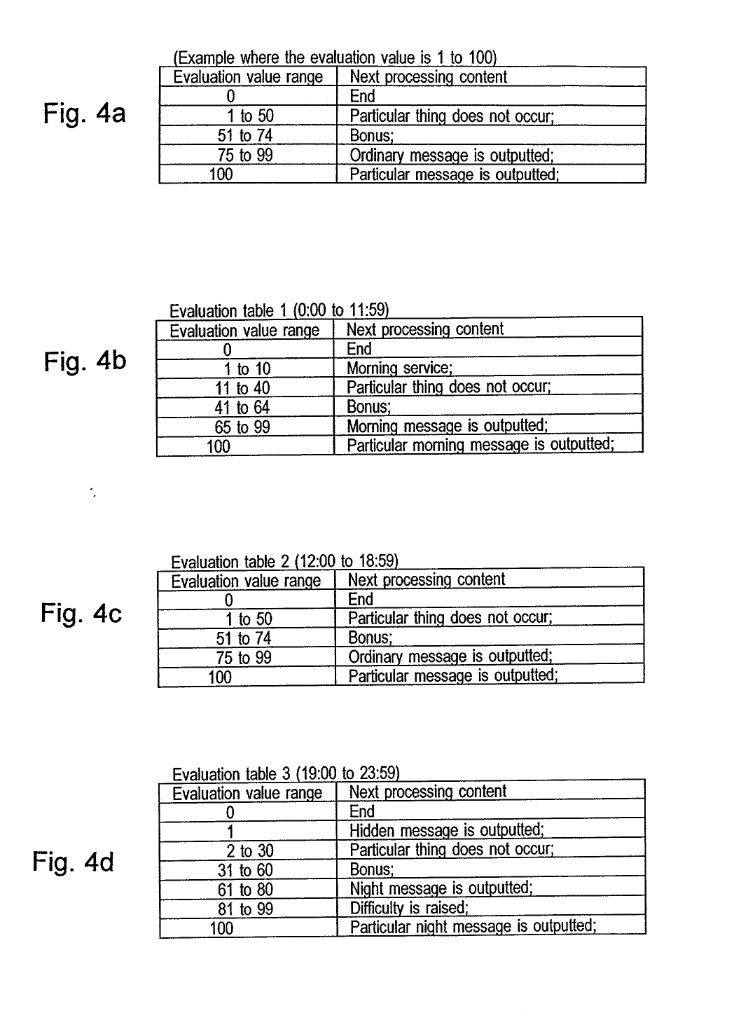

FIG. 4a shows a structural example of the evaluation table. The evaluation table shown in FIG. 4a (also the evaluation table shown in FIG. 4b which will be explained later) is only an example and the present invention is not limited thereto.

The evaluation table is formed, as shown in FIG. 4a, of aggregation of data forming a pair of the range of evaluation value and processing content corresponding to such range of evaluation value. Since the user's evaluation value has a certain spreading, the evaluation value is set corresponding to the processing content as the range of evaluation value having a certain spreading in the evaluation table. The processing corresponding to the range of evaluation value to which the user's evaluation value belongs is executed in the next scenario.

In this embodiment, the evaluation table in which the evaluation value range corresponds to the processing content is used, but the present invention is not limited thereto and it is also possible to use the evaluation table in which the processing content is set corresponding to each value of the evaluation values.

On the other hand, the three evaluation tables 1, 2, 3 are respectively sorted depending on the time zones as illustrated in FIGS. 4b to 4d for the scenario data. Namely, as explained above, the evaluation table 1 is used when the current time belongs to the time zone up to 11:59 from 00:00, while the evaluation table 2 for the time zone up to 18:59 from 12:00 and the evaluation table 3 for the time zone up to 23:59 from 19:00. Moreover, the evaluation value range is different depending on each evaluation table and moreover the processing content for the evaluation value range is also different. Thereby, the processing of the content changing in various manners can be selected depending on the difference of current time.

In this embodiment, each evaluation table has its own content depending on the range of the current time, but it is also possible in addition to such a manner that the range of the passage time, for example, from the start of game is previously set and thereby a plurality of evaluation tables of different content for each range of passage time are used selectively.

Processing of operation determining unit:

The operation determining processing is executed in the task. FIG. 5 is a flowchart schematically indicating the processing of the operation determining unit 209. In the operation determining unit 209, the user's operation content is acquired from the log data (S 501). The acquired operation content is compared with that in the progress content of the scenario data to determine the user's operation content is correct or not (S 502). When the user's operation is correct, the operation determining result is defined as “correct” (S 503) and if the user's operation is not correct, the operation determining result is defined as “fault” (S 504).

In this embodiment, the operation is determined only with single operation of user, but it is naturally possible that a plurality of operations are used for determination and the operation determining result is set in many fine levels. In this case, it is naturally possible to set the user's evaluation value in more fine levels and thereby the processing can be selected from various possibilities.

Processing by branching processing unit:

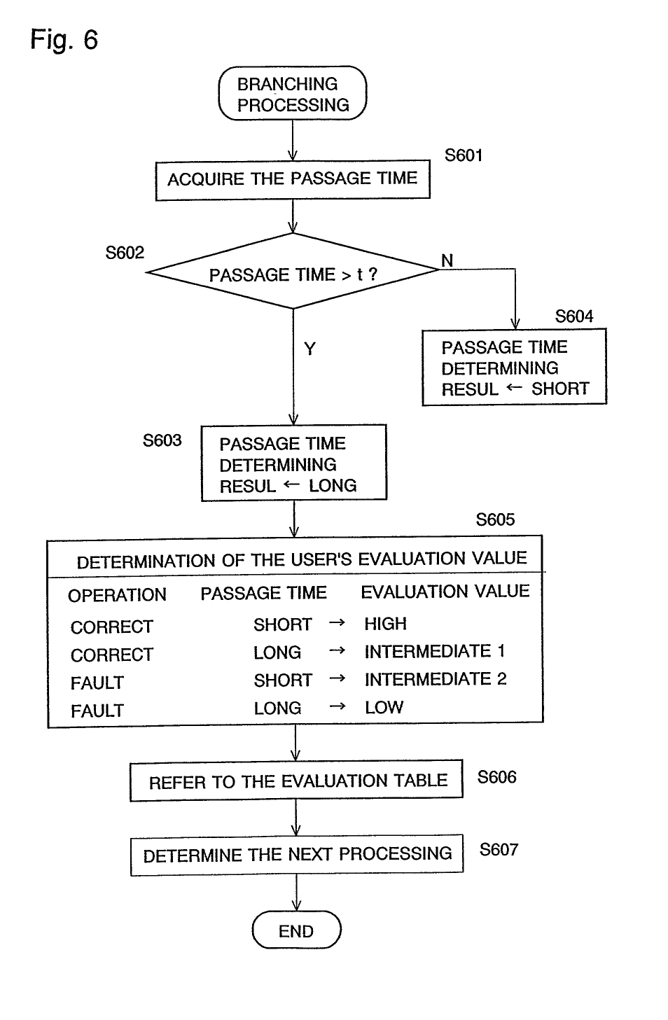

The branching processing is executed in the task. FIG. 6 is a flowchart schematically indicating the processing of the branching processing unit 210. In the branching processing unit 210, the passage time up to the just preceding user's operation from the start of game is acquired from the software timer measuring unit 204 (S 601). Whether the acquired passage time is longer than the predetermined time t or not is determined (S 602). When the passage time is longer than the time t, the determination result of passage time is defined as “long” (S 603) and when the passage time is shorter than the time t, the result is defined as “short” (S 604).

Next, the user's evaluation value is determined based on the determination result of operation by the operation determining unit 209 and the passage time determination result explained above (S 605). The practical processing of this step S 605 is performed as explained below.

a) When the operation determining result is “correct” and the passage time determining result is “short”, the evaluation value is “high”.

b) When the operation determining result is “correct” and the passage time determining result is “long”, the evaluation value is “intermediate 1”.

c) When the operation determining result is “fault” and the passage time determining result is “short”, the evaluation value is “intermediate 2”.

d) When the operation determining result is “fault” and the passage time determining result is “long”, the evaluation value is “low”.

This user's evaluation value indicates the level of skill of users. The practical values of “high”, “intermediate 1”, “intermediate 2” and “low” of the evaluation value can be determined freely. As an example, it is preferable that “high” is set to 100, “intermediate 1” to 80, “intermediate 2” to 60 and “low to 30.

Then, in accordance with the determined user's evaluation value, the evaluation table selected in the STEP 005 of FIG. 3 (evaluation table 1 in the STEP 002) is referred (S 606) to determine the next content to be processed (step 607). When the current time is 14:00 and the evaluation value is determined as “80” as an example, the evaluation table 2 is used in this case because the current time is 14:00. Since the user's evaluation value is “80”, the evaluation value belongs in the ranged of “75 to 99” by referring to the evaluation table 2 and therefore the next processing content is “ordinary message output”.

As explained above, since the evaluation value as the level of skill of users is determined, in the game machine of this embodiment, based on the passage time from the start of game and “correct” and “fault” determining result for the users operation content, the processing content corresponding to the evaluation value range to which the evaluation value belongs is determined in the evaluation table and moreover only one evaluation table among different three tables is used depending on the current time, the processing contents changing in various manners can be executed selectively depending on the skill of users and playing time and date. Moreover, since the users can enjoy different processing development, the present invention assures an advantage that users will not be tired of playing the game even after he has played the game many times.

In this embodiment, on the occasion of determining the passage time, the predetermined time t is defined as the reference time but it is naturally possible to set a plurality of reference times in place of the time t and thereby the more fine passage time determining result can be set easily. In this case, since the user's evaluation value can be set in the more detail steps, it is now also possible to selectively execute the various kinds of processing contents changing in the various manners.

In the embodiment explained above, the present invention is applied to a computer game machine as an example, but it is naturally possible to apply the present invention to various data processing other than the game programs.

What is claimed is:

1. A data processing control system, comprising:
control means for controlling a process based on a scenario data having a progress content of a predetermined processing and an evaluation table including the predetermined evaluation value and the corresponding processing content;
log recording means for recording the users operation content as a log data;
measuring means for measuring a passage time from a predetermined timing;
operation determining means for determining the users operation content based on the progress content of scenario data and the log data; and
branching processing means for determining a users evaluation value based on a determining result of the operation determining means and the passage time and also determining a next processing content based on the determined evaluation value and the evaluation table.

2. A data processing control system according to claim 1, further comprising:
timer means for detecting the current time;
timer acquiring means for extracting the current time at the user's operation input time from the timer means;
said scenario data including a plurality of evaluation tables corresponding to each predetermined time zone; and
said branching processing means being adapted to determine the users evaluation value based on the determining result of the operation determining means and the passage time and to determine the next processing content based on the determined evaluation value and the evaluation table corresponding to the time zone to which the current time belongs.

3. A data processing control system according to claim 1, further comprising:
timer means for detecting the current time;
timer acquiring means for acquiring the current time at the users operation input time from the timer means;
said scenario data including a plurality of evaluation tables for each predetermined passage time zone; and
said branching processing means being adapted to determine the users evaluation value based on the determining result of the operation determining means and the passage time and to determine the next processing content based on the determined evaluation value and the evaluation table corresponding to the passage time zone to which the passage time belongs.

4. A data processing control method comprising the steps of,
(1) controlling the processing based on the scenario data having a progress content of a predetermined processing and an evaluation table including a predetermined evaluation values and corresponding processing content thereof;
(2) measuring the passage time from the predetermined start timing;
(3) determining the user's operation content based on the progress content of scenario data and record data of the user's operation content; and
(4) determining the user's evaluation value based on the operation content determined in the step (3) and the passage time measured in the step (2) and also determining the next processing content based on the determined evaluation value and the evaluation table.

5. A data processing control method according to claim 4, further comprising a step for acquiring the current time at the user's operation input time from the timer apparatus, said scenario data including a plurality of evaluation tables for each predetermined time zone, said step (4) being adapted to determine the user's evaluation value on the basis of the operation content determined in the step (3) and the passage time measured in the step (2) and to determine the next processing on the basis of the determined evaluation value and the evaluation table corresponding to the time zone to which the current time belongs.

6. A computer-readable recording medium in which a program for executing the data processing control method according to claim 4 on a computer, is recorded.

7. A computer-readable recording medium in which a program for executing the data processing control method according to claim 5 on a computer, is recorded.
